(19) United States
(12) Patent Application Publication
(10) Pub. No.: US 2010/0242654 A1
(43) Pub. Date: Sep. 30, 2010

(54) Control Stick Apparatus

(75) Inventor: John Michael Corney, Bredhurst (GB)

Correspondence Address: KENYON & KENYON LLP, ONE BROADWAY, NEW YORK, NY, 10004, US

(73) Assignee: BAE SYSTEMS PLC, Greater London (GB)

(21) Appl. No.: 12/227,958

(22) PCT Filed: Nov. 11, 2008
(86) PCT No.: PCT/GB2008/051050

§ 371 Date: Jun. 9, 2010

(30) Foreign Application Priority Data
Dec. 19, 2007 (EP) 07270077.6
Dec. 19, 2007 (GB) 0724680.4

(51) Int. Cl. G05G 5/05; G05G 1/04; G05G 9/02

(52) U.S. Cl. 74/471 XY; 74/523; 74/491

(57) ABSTRACT

A stick control apparatus includes a member, a fixed location and a pivot point arranged so the member can pivot with respect to the fixed location to follow a deflection axis. A C-shaped spring engages indentation arrangements and provides a bias force to return the member to a predefined position on the deflection axis from any point along the deflection axis.

### RELATED APPLICATION INFORMATION

This application is a United States National Phase Patent Application of International Patent Application No. PCT/GB2008/051050 which was filed on Nov. 11, 2008, and claims priority to British Patent Application No. 0724680.4, filed on Dec. 18, 2007, and claims priority to European Patent Application No. 07270077.6, filed on Dec. 18, 2007, the disclosures of each of which are incorporated herein by reference.

### FIELD OF THE INVENTION

The present invention relates to a control stick apparatus, in particularly, but not exclusively, a control stick apparatus with a single bias element arranged to bias the control stick to a predetermined central location.

### BACKGROUND INFORMATION

Control stick apparatus and hand controllers are used in a variety of applications and are common in the aerospace, robotic and video game industries.

Two axes of operation for the stick control apparatus are normally provided, that is lateral motion and longitudinal motion. The two axes of operation will normally be arranged such that they are at right angles with respect to one another.

Frequently, control stick apparatus are designed such that a stick member returns to a predetermined central location or null position when released by an operator. This feature usually employs the use of a return spring arrangement including at least two springs for each axis of operation.

### SUMMARY OF THE INVENTION

According to one aspect of the present invention, a control stick apparatus includes a member, a fixed location arranged such that the member can pivot with respect to the fixed location, wherein the member is arranged to be displaced about a pivot to follow a deflection axis and a predefined location is located along the deflection axis, and a single bias element arranged between the member and the fixed location such that in operation the single bias element will act between the member and the fixed location to cause the member to return to the predefined location from a displaced position along the deflection axis.

In this manner, a single bias element can be used to return the stick to a predetermined location from any point along the deflection axis.

The member may include an indentation arrangement, the fixed location may include an indentation arrangement and the single bias element may be arranged to engage each indentation arrangement.

The indentation arrangement of the member may include two arms each with indentations, wherein each arm may be located either side of at least part of the fixed location and the single bias element may be arranged to engage the indentations of each arm. Alternatively, the indentation arrangement of the fixed location may include two arms each with indentations, wherein each arm may be located either side of at least part of the member and the single bias element may be arranged to engage the indentations of each arm.

Force applied by the single bias element to return the member to the predefined location may be proportional to force applied to displace the member from the predefined location along the deflection axis.

The single bias element may be dimensioned such that the width of the single bias element is greater than the thickness of the single bias element.

The single bias element may be a pre-loaded substantially C-shaped spring. The substantially C-shaped spring may include a space between each end of the C-shaped spring that is dimensioned to provide a predefined breakout threshold for force applied to rotate the member from the predefined location along the deflection axis.

The pivot between the fixed location and the member may be located such that the member and single bias element act as a first class lever arrangement. Alternatively, the pivot between the fixed location and the member may be located such that the member and single bias element act as a third class lever arrangement.

The member may arranged to pivot with respect to the fixed location about a second deflection axis and a second single bias element may be arranged between the member and the fixed location such that in operation the second single bias element will act between the member and the fixed location to cause the member to return to the predefined location from a displaced position long the second deflection axis.

The member may incorporate a control stick for a vehicle. Alternatively, the member may be attached to a control stick for a vehicle via a linkage mechanism.

At least one drive actuator may be arranged between a fixed location and the member to actively drive the member in a predetermined manner.

### BRIEF DESCRIPTION OF THE DRAWINGS

FIG. 1a illustrates in elevation a stick control apparatus according to an embodiment of the present invention wherein a stick member is in a central location.

FIG. 1b illustrates in elevation a stick control apparatus according to an embodiment of the present invention wherein a stick member is in a displaced position.

FIG. 1c illustrates in elevation a stick control apparatus according to an embodiment of the present invention wherein a stick member is in a displaced position.

FIG. 2 illustrates in perspective view a C-shaped spring according to an embodiment of the present invention.

FIG. 3 illustrates in partial perspective view an embodiment according to an embodiment of the present invention that incorporates a two part indentation arrangement carried by a fixed location.

FIG. 4a illustrates in elevation a stick control apparatus according an embodiment of the present invention wherein a stick member is in a central location.

FIG. 4b illustrates in elevation a stick control apparatus according to an embodiment of the present invention wherein a stick member is in a displaced position.

FIG. 4c illustrates in elevation a stick control apparatus according to an embodiment of the present invention wherein a stick member is in a displaced position.

FIG. 5 schematically illustrates a stick control apparatus according to an embodiment of the present invention wherein the stick member is connected via a linkage mechanism to a stick handgrip to be operated by an operator.

FIG. 6 schematically illustrates a stick control apparatus according to an embodiment of the present invention wherein the stick member is actively driven by an actuator.

### DETAILED DESCRIPTION

Exemplary embodiments of the present invention will now be described in more detail, by way of example only, with reference to the accompanying drawings.

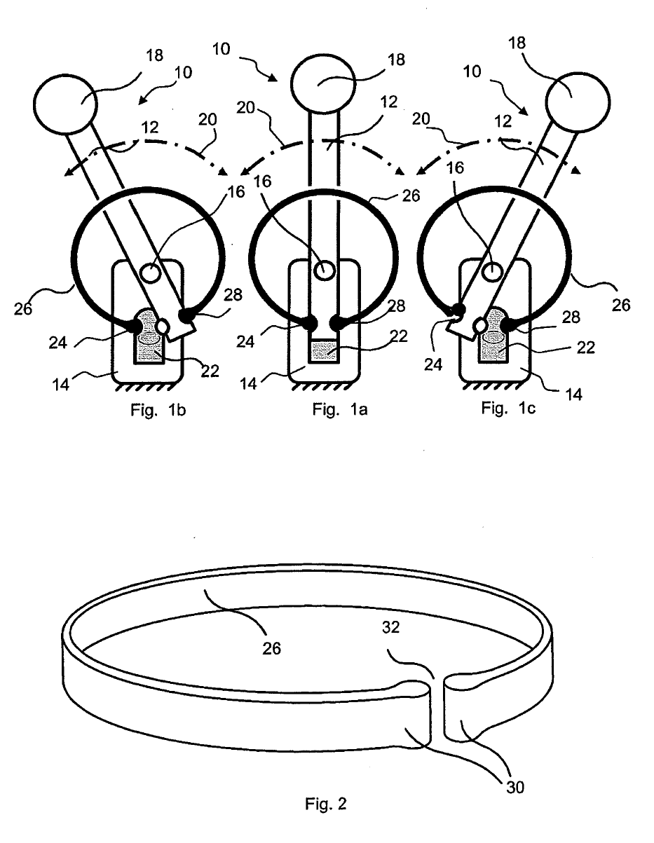

Referring to FIG. 1a, there is illustrated a control stick apparatus 10 including a member 12, a fixed location 14 and a pivot point 16 arranged such that the member 12 can pivotally rotate with respect with the fixed location 14 about the pivot point 16.

The member 12 incorporates a control stick 18, for example a handgrip, to be engaged by an operator of the control stick apparatus 10 to displace the member 12 about the pivot point 16 so as to follow a deflection axis 20.

The fixed location 14 includes a fixed abutment 22 upstanding from the fixed location 14 with an indentation arrangement 14 arranged to receive one end of a C-shaped spring 26.

Furthermore, the member 12 also includes an indentation arrangement 28 arranged to receive the other end of the C-shaped spring.

The C-shaped spring can be preloaded with a break-out threshold force to ensure that the member 12 is returned to a predefined location, i.e. a central location as illustrated in FIG. 1a, from a displaced positioned wherein the member 12 has been moved along the deflection axis 20.

Referring to FIG. 1b, wherein like references have been used to indicate similar integers to those described with reference to FIG. 1a, the member 12 has been displaced along the deflection axis 20 by rotation of the member 12 about the pivot point 16, in this case to the left. The rotation of the member 12 about pivot point 16 causes the C-shaped spring 26 to deflect and generate a force proportional to the force applied to displace the member from the predefined location of FIG. 1a. It will be noted that one end of the C-shaped spring 26 remains stationary against the indentation arrangement 14 associated with the fixed abutment 22. Accordingly, when force applied by an operator to displace the member is reduced or removed, the force applied by the C-shaped spring will return the member 12 to the predefined location illustrated in FIG. 1a.

Referring to FIG. 1c, wherein like references have been used to indicate similar integers to those described with reference to FIG. 1a, the member 12 has been displaced along the deflection axis 20 by rotation of the member 12 about the pivot point 16, in this case to the right. The rotation of the member 12 about pivot point 16 causes the C-shaped spring 26 to deflect and generate a force proportional to the force applied to displace the member from the predefined location of FIG. 1a. It will be noted that one end of the C-shaped spring 26 remains stationary against the indentation arrangement 14 associated with the fixed abutment 22. Again, when force applied by an operator to displace the member is reduced or removed, the force applied by the C-shaped spring will return the member 12 to the predefined location illustrated in FIG. 1a.

It will be understood, that the indentation arrangements 24 and 28 are of similar profile and designed so that at the predefined location, that is shown in FIG. 1a, the ends of the C-shaped spring 26 simultaneously engages both indentation arrangements 24 and 28.

When the member 12 is in the predefined location, FIG. 1a, it is held in alignment with fixed location 14 by the preloaded break-out threshold force of the C-shaped spring 26. When a deflection force is applied to the control stick 18 initially no movement of the member 12 will occur until the preload force of the C-shaped spring 26 is overcome and the member 12 will then be allowed to move away from the predefined location with a progressively increasing force provided by the C-shaped spring 26 as it is rotated about the pivot point 16 along the deflection axis 20.

It will be understood that both indentation arrangements 24 and 28 are arranged such that if the member 12 is rotated about the pivot point 16, one portion of the indentation arrangement 24 will remain in engagement with a first end of the C-shaped spring 26 and one portion of the indentation arrangement 28 will remain in engagement with a second end of the C-shaped spring 26. Should the member 12 be rotated about the pivot point 16, in an alternative direction, passed the predetermined location, an opposition portion of the indentation arrangement 24 will engage with the second end of the C-shaped spring 26 and an opposite portion of the indentation arrangement 28 will engage with the first end of the C-shaped spring 26. Thus, as the member passes through the predetermined location, that shown in FIG. 1a, engagement of indentation arrangements 24 and 28 switches from portions of the indentation arrangements 24 and 28 arranged on opposite sides of the fixed abutment 22 and member 12, respectively, to engage different ends of the C-shaped spring 26.

In order to minimize the local stress levels within the indentation arrangements 24 and 28 and at the ends of the C-shaped spring 26, the ends of the C-shaped spring can be shaped, such that in operation of the stick control apparatus 10, the contact between the ends of the C-shaped spring 26 and the indentation arrangements 24, 28 is of a rolling nature rather than of a sliding nature. Referring to FIG. 2, a C-shaped spring 26 has a substantially rectangular cross-section, with its width significantly greater than its thickness, so as to ensure greater stability of the C-shaped spring 26 as it is deflected. The profile of the ends 30 of the C-shaped spring 26 allow a rolling motion along the indentation arrangements 24, 28 as the C-shaped spring 26 is deflected, whilst the smoothly curved profile of the ends 30 of the C-shaped spring 26 minimize stress concentrations at high deflections of the C-shaped spring 26. A gap 32 between the ends 30 of the C-shaped spring 26 is set during the manufacturing stage so as to present the desired break-out threshold force to be applied to the control stick 18 whilst in the predefined location shown in FIG. 1a.

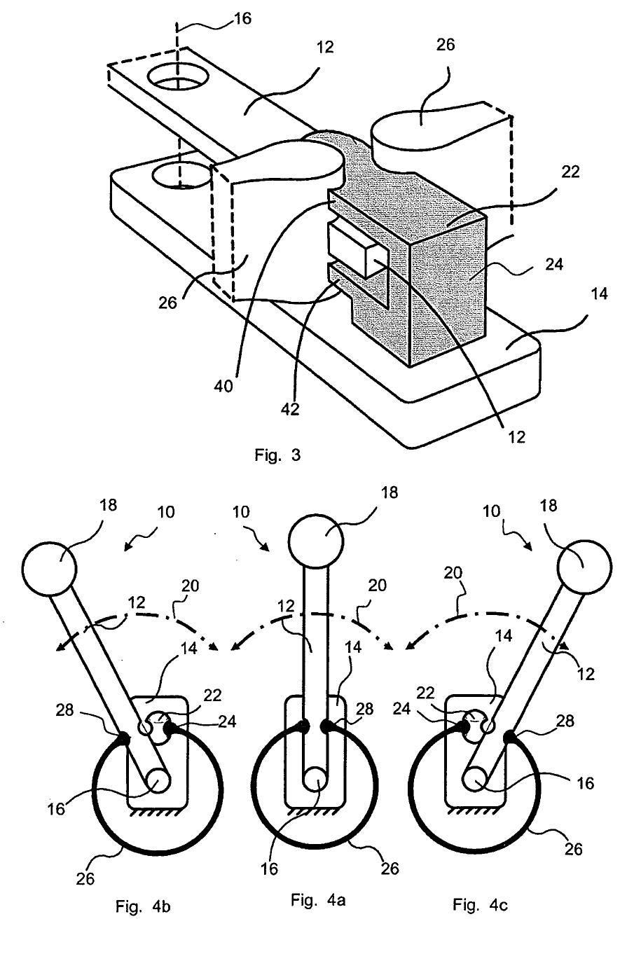

Referring to FIG. 3, wherein like references have been used to indicate similar integers to those described with reference to FIGS. 1a, 1b and 1c, introduction of further features within the control stick apparatus 10 will increase the stability of the C-shaped spring 26 under high deflection loading conditions so that skew loading on the C-shaped spring 26 is mitigated. When the C-shaped spring 26 is deflected, it is supported at one end of the indentation arrangement 28 of the member 12 and at the other end by the indentation arrangement 24 associated with the fixed location 14. In order to improve the stability of the C-shaped spring 26, one of the indentation arrangements, in this particular example indentation arrangement 24, includes two arms 40 and 42 each with indentations arranged to receive one end of the C-shaped spring 26. In effect, the two arms 40 and 42 provide a dual parallel set of indentations that straddle the indentation arrangement 28 of the member 12. As will be observed, there are substantially equal and opposite indentations either side of arms 40 and 42 to receive an end of the C-shaped spring 26 depending on the direction of rotation of the member 12 about the pivot point 16.

The section of the member 12 between the arms 40 and 42 can be of greater thickness than each of the arms 40 and 42 of the indentation arrangement 24 in order to equalize the stress concentrations as the C-shaped spring 26 is deflected.

With the arrangement of FIG. 3, as the C-shaped spring 26 is deflected, it remains located between the indentation arrangement 28 of the member 12 and the arms 40 and 42 of the indentation arrangement 24 associated with fixed location 14. This three-point mechanical constraint acts to provide stability to the C-shaped spring 26. It will be noted that further constraints to the C-shaped spring 26 could be necessary, for example in high vibration environments.

It will be understood, that alternative physical arrangements of the control stick apparatus are possible. For example, there can be benefits within particular installations of operating the control stick apparatus as a third class lever arrangement rather than the first class lever arrangement described with reference to FIGS. 1a, 1b and 1c.

Referring to FIG. 4, wherein like references have been used to indicate similar integers to those described with reference to FIGS. 1a, 1b and 1c, it will be observed that the relative positions of the pivot point 16 and the indentation arrangements 24 and 28 have been reversed. However, the principle of operation of the control stick apparatus 10 remains unchanged.

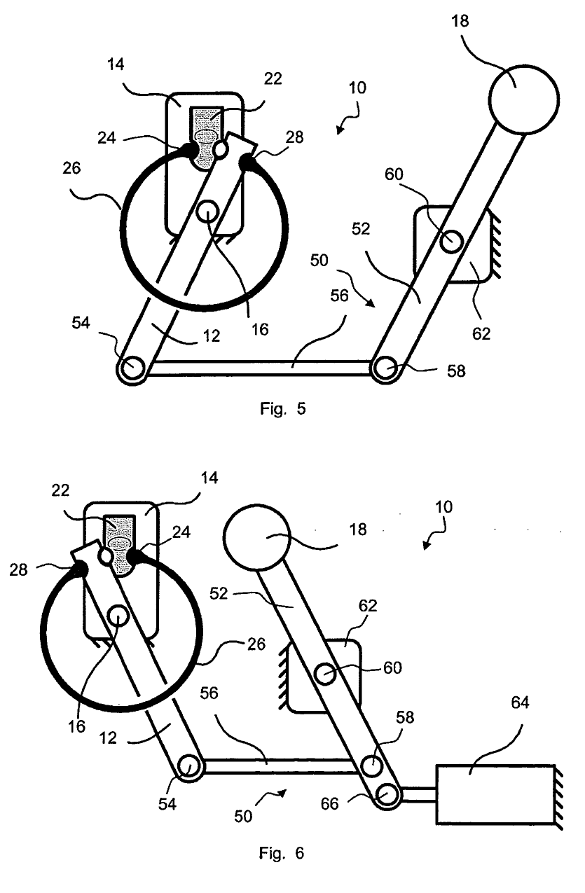

Further mechanical arrangements are also possible in the context of specific installation requirements. For example, referring to FIG. 5, wherein like references have been used to indicate similar integers to those described with reference to FIGS. 1a, 1b and 1c, the control stick apparatus 10 further includes a linkage arrangement 50 arranged between a control stick 52 and the member 12. As illustrated, the linkage arrangement 50 includes a pivot point 54 between the member 12 and a linkage 56 and a pivot point 58 between the control stick 52 and the linkage 54. The control stick 52 is also pivotally mounted at pivot point 60 to a fixed position 62. In this embodiment, the control stick 52 is remote from the C-shaped spring 26, member 12 and fixed location 14. A large variety of other alternative physical arrangements are possible with the same operating concept to that described with reference to the invention.

Recent innovations in the aerospace industry involve the introduction of “active” force elements within a control stick apparatus, for example an active inceptor or active stick. The term “active” is used in this context to indicate powered operation of the control stick apparatus using a suitable drive arrangement, for example, actuators or motors.

Referring to FIG. 6, wherein like references have been used to indicate similar integers to those described with reference to FIG. 5, the control stick 52 includes an actuator 64 arranged between a fixed point and pivotally mounted to the control stick 52 via a pivot point 66 so as to drive the control stick 52 to provide a perceived force feel to an operator when the control stick is moved by applying a force to the control stick 52. However, in this embodiment the control stick 52 includes a back-up “passive” spring, C-shaped spring 26, which is able to provide reversionary feel forces should the active components of the embodiment fail. Again, there are a variety of alternative mechanical implementations for such an active control stick arrangement.

For simplicity, the description of the control stick apparatus 10 has been expressed in terms of a single deflection axis 20, although the operating concept of the control stick apparatus 10 can equally be applied to a two-axes control stick apparatus with the proviso that the component parts associated with the lateral and longitudinal axes of the control stick apparatus 10 are mechanically independent of one another.

1-14. (canceled)

15. A control stick apparatus, comprising:
a member;
a fixed location arranged such that the member can pivot with respect to the fixed location;
wherein the member is arranged to be displaced about a pivot to follow a deflection axis and a predefined location is located along the deflection axis; and
a single bias element arranged between the member and the fixed location such that in operation the single bias element will act between the member and the fixed location to cause the member to return to the predefined location from a displaced position along the deflection axis.

16. The control stick apparatus according to claim 1, wherein:
the member includes an indentation arrangement,
the fixed location includes an indentation arrangement, and
the single bias element is arranged to engage each indentation arrangement.

17. The control stick apparatus according to claim 2, wherein:
the indentation arrangement of the member includes two arms each with indentations,
each arm is located either side of at least part of the fixed location, and
the single bias element is arranged to engage the indentations of each arm.

18. The control stick apparatus according to claim 2, wherein:
the indentation arrangement of the fixed location includes two arms each with indentations,
each arm is located either side of at least part of the member, and
the single bias element is arranged to engage the indentations of each arm.

19. The control stick apparatus according to claim 1, wherein force applied by the single bias element to return the member to the predefined location is proportional to force applied to displace the member from the predefined location along the deflection axis.

20. The control stick apparatus according to claim 1, wherein the single bias element is dimensioned such that the width of the single bias element is greater than the thickness of the single bias element.

21. The control stick apparatus according to claim 1, wherein the single bias element is a pre-loaded substantially C-shaped spring.

22. The control stick apparatus according to claim 7, wherein the substantially C-shaped spring includes a space between each end of the C-shaped spring that is dimensioned to provide a predefined breakout threshold for force applied to rotate the member from the predefined location along the deflection axis.

23. The control stick apparatus according to claim 1, wherein the pivot between the fixed location and the member is located such that the member and single bias element act as a first class lever arrangement.

24. The control stick apparatus according to claim 1, wherein the pivot between the fixed location and the member is located such that the member and single bias element act as a third class lever arrangement.

25. The control stick apparatus according to claim 1, wherein the member is arranged to pivot with respect to the fixed location about a second deflection axis and a second single bias element is arranged between the member and the fixed location such that in operation the second single bias element will act between the member and the fixed location to cause the member to return to the predefined location from a displaced position along the second deflection axis.

26. The control stick apparatus according to claim 1, wherein the member incorporates a control stick for a vehicle.

27. The control stick apparatus according to claim 1, wherein the member is attached to a control stick for a vehicle via a linkage mechanism.

28. The control stick apparatus according to claim 1, wherein at least one drive actuator is arranged between a fixed location and the member to actively drive the member in a predetermined manner.
